(19) United States
(12) Patent Application Publication
(10) Pub. No.: US 2007/0200699 A1
(43) Pub. Date: Aug. 30, 2007

(54) Light barrier arrangement

(75) Inventor: Volker Rohbeck, Rohrmoos (DE)

Correspondence Address: VENABLE LLP, P.O. BOX 34385, WASHINGTON, DC, 20043-9998, US

(73) Assignee: Leuze Lumiflex GmbH & Co. KG, Furstenfeldbruck (DE)

(21) Appl. No.: 11/702,169

(22) Filed: Feb. 5, 2007

(30) Foreign Application Priority Data
Feb. 4, 2006 (DE) 10 2006 005 152.1

(51) Int. Cl. G08B 13/18; G01J 1/04

(52) U.S. Cl. 340/555; 250/227.14

(57) ABSTRACT

A light barrier arrangement for detecting objects in an area to be monitored includes a transmitting unit comprising a predetermined number of transmitters which emit light rays, a first storage unit, and a first integrated interface unit. The light barrier arrangement further includes a receiving unit comprising a predetermined number of receivers, each receiver being aligned with an associated transmitter to receive the light rays from the associated transmitter, a second storage unit, and an second integrated interface unit. Operational parameters of the transmitters and receivers are stored in each of the first and second storage units. The first interface unit is operative to transmit the operational parameters to and receive the operational parameters from the receiving unit. The second interface unit is operative to receive the operational parameters from and transmit the operational parameters to the transmitting unit.

### CROSS-REFERENCE TO RELATED APPLICATION

This application claims the priority of German Patent Application No. 10 2006 005 152.1-52, filed on Feb. 4, 2006, the subject matter of which is incorporated herein by reference.

### BACKGROUND

The invention relates to a light barrier arrangement.

Light barrier arrangements of the type discussed herein are formed with individual light barriers, in particular multi-beam light barriers. The multi-beam light barriers are typically provided with a transmitting unit and a receiving unit, which are arranged at opposite edges of the area to be monitored. The transmitting unit includes a predetermined number of transmitters emitting light rays, while the receiving unit includes a predetermined number of receivers to receive the emitted light rays. Each transmitter is coordinated with a receiver, so that the light rays emitted by each transmitter are conducted to an associated receiver if the monitored area is clear. If an object enters the monitored area, the optical path between at least one transmitter and the coordinated receiver is interrupted, which causes an object-detection signal to be generated in the receiving unit.

Light barrier arrangements may be embodied as light grids or light curtains, such as the light grid disclosed in German Patent Document DE 39 39 191 A1. The transmitters and receivers of the light grid are activated cyclically, and synchronized optically with the light rays emitted by one of the transmitters. Light grids of this type are used in the field of personal protection, to secure danger zones on machines.

The respective operating mode for a light grid is defined by presetting parameters for its receivers and transmitters. One problem with light grids of this type is that if a defect occurs in the transmitting unit or the receiving unit, the defective transmitting or receiving unit is replaced with a new unit. The respective operating parameters must then be entered into the new transmitting or receiving unit. This results in a time-consuming process.

One approach to reduce time associated with entry of the new parameters into the light grid, following a replacement of a transmitting or receiving unit, is to link the light grid via a bus system to a control unit, in which the parameters may be stored centrally. The disadvantage of this layout is that such a light grid connection represents a considerable expenditure in circuitry. In addition, a bus system of this type for the optional connection to the control unit is not available in many light-grid applications.

Another method is to use plug-in modules for light grids or light barrier arrangements. In this method, the transmitting unit and the receiving unit may respectively be connected to one plug-in module. The individual parameters for the transmitting or receiving unit may be stored in the plug-in modules. Following the replacement of a defective transmitting or receiving unit, the new unit may retrieve the parameters from the respective plug-in module. However, the plug-in modules are additional and separately connected units, the use of which results in an undesirable increase in the structural expenditure for the light grid.

### SUMMARY

It is therefore the object of the present invention to provide a light barrier arrangement, which makes it possible to input parameters with the lowest possible expenditure.

The above and other objects are accomplished according to the invention, which in one embodiment a light barrier arrangement for detecting objects in an area to be monitored, comprising: a transmitting unit including: a predetermined number of transmitters which emit light rays, a first storage unit, and a first integrated interface unit; and a receiving unit including: a predetermined number of receivers, each receiver being aligned with an associated transmitter to receive the light rays from the associated transmitter, a second storage unit, and an second integrated interface unit; wherein operational parameters of the transmitters and receivers are stored in each of the first and second storage units, the first interface unit is operative to transmit the operational parameters to and receive the operational parameters from the receiving unit, and the second interface unit is operative to receive the operational parameters from and transmit the operational parameters to the transmitting unit.

Thus, according to the invention, the parameters for the transmitters and receivers are stored in the transmitting unit as well as in the receiving unit, so that these parameters may optionally be input via the interface unit from the transmitting unit to the receiving unit and vice versa. Following the replacement of a defective transmitting or receiving unit with a new unit, the parameters may be transmitted from the non-defective unit and read into the new unit, without requiring external parameter storage devices.

For example, if the receiving unit of a light barrier arrangement fails during the operation and is replaced with a new receiving unit, the required parameters may be transmitted from the non-defective transmitting unit via the interface unit to the new receiving unit, so that the newly installed receiving unit is immediately fully functional, without requiring additional adjustments. The same is true in reverse for replacing a defective transmitting unit with a new transmitting unit.

The respective new transmitting or receiving unit does not have to be opened up for the parameter input, nor does it have to be connected to overriding controls, specific system connectors, or the like. The parameter input into the new transmitting or receiving unit for the light barrier arrangement may therefore be realized quickly, easily and with little structural expenditure. The new transmitting or receiving unit, which replaces the defective transmitting or receiving unit, therefore may be connected to the light barrier arrangement immediately after removing it from packaging and is fully functional without delay, which results in high operating comfort for the light barrier arrangement.

A line-conducted transmission of parameters via the interface unit is also possible, wherein the interface unit in the transmitting unit and in the receiving unit in this case is embodied as serial interface unit to which a line may be connected.

It is particularly advantageous if the interface units are designed for the non-contacting transmission of parameters. According to one embodiment, the parameters are transmitted via radio signals. The interface units each includes a respective transmitting or receiving module to emit or receive radio signals.

According to another embodiment, the parameters are transmitted optically via the interface unit. A transmitter of the transmitting unit and a receiver of the receiving unit that are utilized for detecting objects during the normal operation of the light barrier arrangement, may advantageously be used for transmitting the parameters from the transmitting unit and the receiving unit. For transmitting the parameters from the receiving unit to the transmitting unit, a transmitting element is provided in the receiving unit and a receiving element is provided in the transmitting unit as additional interface unit components. The parameters are transmitted to the receiving element via light rays emitted by the transmitting element.

The storage units of the transmitting unit and the receiving unit are embodied as non-volatile storage units to ensure a fail-safe storage of the parameters.

In particular, when using the light barrier arrangement for the protection of persons, the parameters are stored fail-safe in the storage units to meet the required safety level. In the light barrier arrangement, which is used for the protection of persons, the receiving unit is provided with a redundant evaluation unit for fail-safe generating of an object detection signal. The redundant evaluation unit comprises two-channel storage unit, which may be used for the fail-safe storage of parameters in the receiving unit. The electronic components of the transmitting unit in the light barrier arrangement are configured with only one channel. To ensure a fail-safe storage of the parameters, the stored parameters are secured by check sums.

The invention generally may be expanded to include multiple layouts of light barrier arrangements, for example, used for securing complex danger zones. The individual light barrier arrangements are provided with identically embodied storage units and interface units, so that parameters may be transmitted between different light barrier arrangements. The individual light barrier arrangements may be embodied as transceivers. A transceiver includes a transmitting unit and a receiving unit, into which the individual receivers and transmitters for the light barrier arrangement are integrated. A deflection unit with deflection mirrors is assigned to the transmitting and receiving unit. The light rays emitted by the individual transmitters penetrate the area to be monitored, are reflected at the deflection mirrors and, in the process, are deflected twice by 90° before being conducted to the associated receivers. The transmitting and receiving unit of each transceiver includes a storage unit for storing the parameters of the individual transmitters and receivers for the light barrier arrangements. Each transceiver is additionally provided with an interface unit. Parameters may be transmitted between two or more transceivers via the interface units. If a transceiver fails, it is replaced with a new transceiver and is supplied with the required operating parameters by the non defective transceiver.

The invention is not limited to multiple layouts of light barrier arrangements. Rather, the invention may in general also be used for sensors that may be embodied as optical sensors. A multiple layout according to the invention generally may also comprise different types of sensors.

### BRIEF DESCRIPTION OF THE DRAWINGS

These and other features and advantages of the invention will be further understood from the following detailed description of the preferred embodiments with reference to the accompanying drawings, which show in:

FIG. 1 is a schematic representation of a light grid according to a first embodiment for the interface units for transmitting the parameters;

FIG. 2 is a schematic representation of a light grid according to a second embodiment for the interface units for transmitting the parameters;

FIG. 3 is a schematic representation of a light grid according to a third embodiment for the interface units for transmitting the parameters.

### DETAILED DESCRIPTION

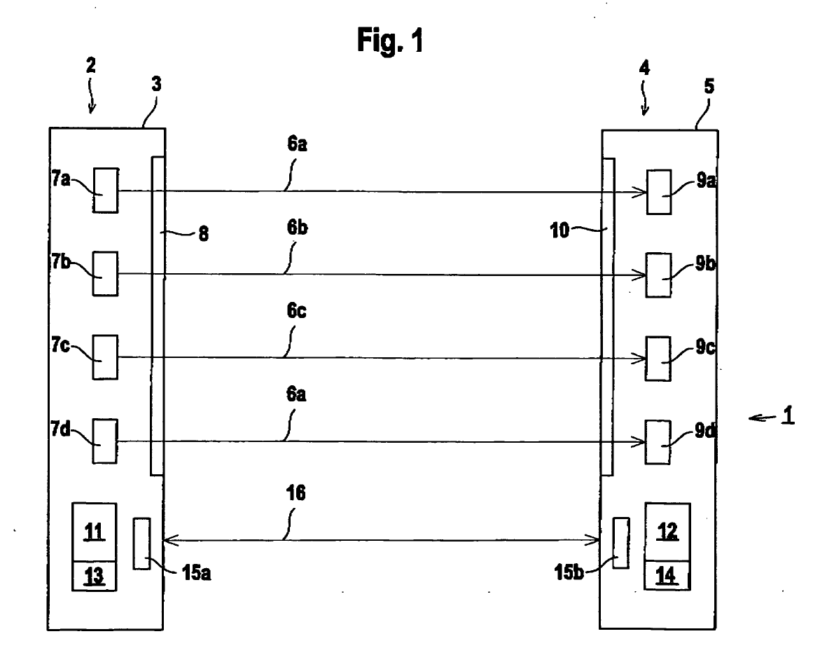

FIG. 1 schematically shows a light barrier arrangement embodied as a light grid 1 for detecting objects within an area to be monitored. The light grid 1 includes a transmitting unit 2, integrated into a first housing 3, and a receiving unit 4 that is integrated into a second housing 5. The transmitting unit 2 and the receiving unit 4 are arranged at opposite edges of the monitored area. The transmitting unit 2 includes a serial arrangement of transmitters 7a-7d, which each emits corresponding light rays 6a-6d. In one embodiment, the transmitters 7a-7d are identically designed. For example, the transmitters 7a-7d are light-emitting diodes, or the like. Transmitting optics (not shown) may be provided to form a beam with the transmitted light rays 6a-6d. The transmitted light rays 6a-6d are conducted through an exit window 8 in the front wall of the housing 5. The receiving unit 4 includes a serial arrangement of receivers 9a-9d. In one embodiment, the receivers 9a-9d are identically designed. For example, the receivers 9a-9d are photodiodes, or the like. The transmitted light rays 6a-6d may be focused onto the receivers 9a-9d with receiving optics (not shown), which may be arranged upstream of the receivers. The light rays 6a-6d, which are emitted by the transmitters 7a-7d and are conducted inside the monitored area, are conducted via an entrance window 10 onto the receivers 9a-9d.

The transmitters 7a-7d and the receivers 9a-9d form cooperating transmitter-receiver pairs, so that the transmitted light rays 6a-6d of each transmitter 7a-7d of a pair impinge on the respective receiver 9a-9d of the pair if the monitored area is clear, as shown in FIG. 1. In this embodiment, the light grid 1 includes four pairs of transmitters 7a-7d and receivers 9a-9d. In general, however, the light grid 1 may include any number of transmitters 7a-7d and receivers 9a-9d. A light barrier arrangement with only one transmitter-receiver pair is also contemplated.

A control unit 11 for triggering the transmitters 7a-7d is integrated into the transmitting unit 2. For example, the control unit 11 may be a microprocessor, or the like. Each individual transmitter 7a-7d is triggered periodically and successively by the control unit 11 during predetermined cycles. An evaluation unit 12 is integrated into the receiving unit 4. When used for the protection of persons, the evaluation unit 12 has a two-channel configuration, including two microprocessors that monitor each other. Each individual receiver 9a-9d is triggered periodically and successively, during predetermined cycles. The triggering of the transmitters and receivers is synchronized optically, for example by impressing an individual coding onto the transmitted light rays 6a of the first transmitter 7a. The signals received at the receivers 9a-9d are evaluated in the evaluation unit 12 for generating an object detection signal, for example, a binary switching signal. If the monitored area is clear, the transmitted light rays 6a-6d from the transmitters 7a-7d impinge without interference on the associated receivers 9a-9d. The switching signal in the switching state “area to be monitored is clear.” If an intervening object is detected in the monitored area, the transmitted light rays 6a-6d from at least one transmitter 7a-7d are interrupted and may no longer reach the associated receiver 9a-9d. The event is recorded in the evaluation unit 12. As a result, the switching signal is in the switching state “object detected.” If the light grid 1 is used for securing a danger zone on a machine, the machine operation is released via the light grid 1 only if the switching signal is in the switching state “area to be monitored is clear.”

The control unit 11 of the transmitting unit 2 is provided with a first storage unit 13. The evaluation unit 12 of the receiving unit 4 is provided with a second storage unit 14. The parameters for the transmitters 7a-7d and receivers 9a-9d, for operating the light grid 1, are respectively stored non-volatile in the storage units 13, 14. Preset data for the modulation of the transmitted light rays 6a-6d or the type and number of transmitted light rays 6a-6d used for the synchronization of the light grid 1, for example, may be stored as relevant parameters for the transmitters 7a-7d in the storage units 13, 14. Threshold values used to rate the signals received by each individual receiver 9a-9d, for example, may be stored as relevant parameters for the receivers 9a-9d while the light grid 1 resolution may be stored as an additional parameter in the storage units 13, 14. The light grid resolution defines a number of transmitted light rays 6a-6d that needs to be interrupted to constitute a valid object detection. Determinations relating to a blanking of the light grid 1 may also be stored as additional parameters in the storage units 13, 14. Such a blanking is used to blank out defined transmitted light rays 6a-6d that are no longer used for the object detection.

To meet the safety requirements for using the light grid 1 in the area of personal protection, the parameters are stored fail-safe in the storage units. Because of the redundant two-channel design of the evaluation unit 12, the second storage unit 14, for example, also has a redundant design to ensure a fail-safe storage of the parameters. The control unit 11 of the transmitting unit 2, and the integrated first storage unit 13, has a single-channel design. For the fail-safe storage in the first storage unit 13, the parameters are secured with check sums. In particular, the parameters may be stored in the first storage unit 13 with double inverting and additionally may be secured with check sums.

Separate interface units are provided in the transmitting unit 2 and the receiving unit 4. The interface units may be used to transmit the parameters from the transmitting unit 2 to the receiving unit 4 and vice versa. In this embodiment, first and second or transmitting and receiving modules 15a, 15b, functioning as interface units, is each integrated respectively with the transmitting unit 2 and receiving unit 4. By using the transmitting and receiving modules 15a, 15b, the parameters may be transmitted bi-directionally with radio signals 16 between the transmitting unit 2 and the receiving unit 4.

In case of a failure of the transmitting unit 2 or the receiving unit 4 during the light grid 1 operation caused by a defect, the failed unit is replaced with a new unit. The operational parameters are transmitted from the non-defective unit, e.g. the non-defective receiving unit 4 or transmitting unit 2, via the associated first or second interface unit 15a, 15b to the newly connected unit. As a result, the light grid 1 is immediately functional, without requiring a teach-in process for the input of parameters into the new unit. In addition, there is no need to provide external parameter storage units. The parameter transmission is advantageously triggered by activating a switch on the transmitting unit 2, the receiving unit 4, or the like. Alternatively, the parameter transmission may be triggered automatically if the respective light grid 1 is clearly identified as new.

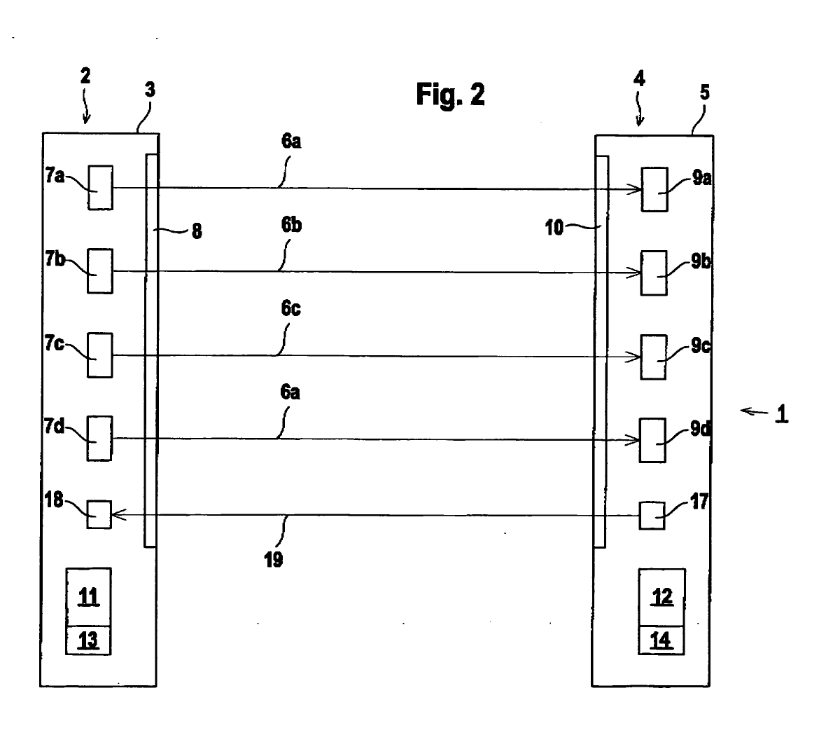

FIG. 2 shows an exemplary embodiment of the light grid 1. The light grid 1 according to FIG. 2 corresponds to the embodiment shown in FIG. 1, except the interface units include optical interface units. The transmitter 7d and the receiver 9d, which are utilized during normal operation of the light grid 1 for detecting objects in the monitored area, are used in this embodiment as components of the optical interface units. The parameters are transmitted from the transmitting unit 2 to the receiving unit 4 via a suitable modulation of light rays 6d, emitted by the transmitter 7d. The optical interface units are supplemented by a transmitting element 17, integrated into the receiving unit 4, and a receiving element 18, integrated into the transmitting unit 2. The transmitting element 17 is, for example, advantageously embodied identically to the transmitters 7a-7d of the light grid 1, while the receiving element 18 is, for example, embodied identically to the receivers 9a-9d of the light grid 1. The parameters are transmitted from the receiving unit 4 to the transmitting unit 2 via light rays 19, emitted by the transmitting element 17 in the direction of the receiving element 18.

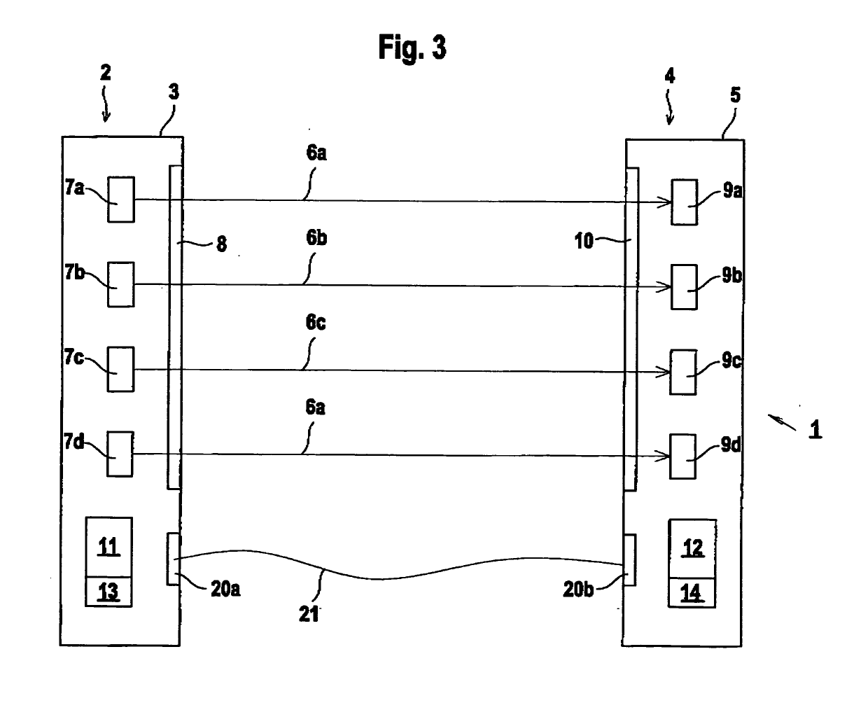

FIG. 3 shows an exemplary embodiment of a light grid 1. The embodiment of FIG. 3 differs from the embodiment of FIG. 1 with respect to the design of the interface units. While in the embodiments of FIGS. 1 and 2, a non-contacting transmission of parameters is described, FIG. 3 shows a line-conducted parameter transmission. Dedicated serial interfaces 20a, 20b are respectively provided in the transmitting unit 2 and the receiving unit 4. The serial interfaces 20a, 20b, e.g., interface units, are linked with a connecting line 21 for transmitting the parameters.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. A light barrier arrangement for detecting objects in an area to be monitored, comprising:
a transmitting unit including:
a predetermined number of transmitters which emit light rays,
a first storage unit, and an first integrated interface unit; and
a receiving unit including:
a predetermined number of receivers, each receiver being aligned with an associated transmitter to receive the light rays from the associated transmitter,
a second storage unit, and
an second integrated interface unit;
wherein operational parameters of the transmitters and receivers are stored in each of the first and second storage units, the first interface unit is operative to transmit the operational parameters to and receive the operational parameters from the receiving unit, and the second interface unit is operative to receive the operational parameters from and transmit the operational parameters to the transmitting unit.

2. The light barrier arrangement according to claim 1, wherein the transmitting unit is a replaceable transmitting unit, which upon becoming defective is replaceable with a replacement transmitting unit, and the second integrated interface unit is operative following an installation of the replacement transmitting unit to transmit the operational parameters of the transmitters from the receiving unit to the installed replacement transmitting unit.

3. The light barrier arrangement according to claim 1, wherein the receiving unit is a replaceable receiving unit, which upon becoming defective is replaceable with a replacement receiving unit, and the first integrated interface unit is operative following an installation of the replacement receiving unit to transmit the operational parameters of the receivers from the transmitting unit to the installed replacement receiving unit.

4. The light barrier arrangement according to claim 1, wherein at least one of the first or second storage unit includes a non-volatile storage unit.

5. The light barrier arrangement according to claim 1, wherein the operational parameters are stored fail-safe in the first and second storage units.

6. The light barrier arrangement according to claim 5, wherein at least one of the first or second storage unit includes two channels.

7. The light barrier arrangement according to claim 5, wherein storage of the operational parameters at least in one of the first or second storage unit is secured with check sums.

8. The light barrier arrangement according to claim 1, wherein the first and second integrated interface units each includes a transmitting/receiving module to transmit and receive a radio signal.

9. The light barrier arrangement according to claim 1, wherein the first and second integrated interface units each includes a serial interface module linked via a conducting line.

10. The light barrier arrangement according to claim 1, wherein the integrated interface units in the transmitting and receiving units comprise an optical interface unit.

11. The light barrier arrangement according to claim 10, wherein the optical interface unit includes:
one of the transmitters of the transmitting unit and an associated one of the receivers of the receiving unit, wherein the operational parameters are transmitted from the transmitting unit to the receiving unit via the light rays emitted by said one transmitter.

12. The light barrier arrangement according to claim 11, wherein the optical interface unit further includes:
a transmitting element integrated into the receiving unit to emit light rays; and
a receiving element integrated into the transmitting unit to receive the light rays transmitted by the transmitting element, wherein the operational parameters are transmitted from the receiving unit to the transmitting unit via the light rays emitted by the transmitting element.

13. The light barrier arrangement according to claim 12, wherein at least one of:
the transmitting element is substantially identical to the transmitters of the transmitting unit, or
the receiving element is substantially identical to the receivers of the receiving unit.

14. A multiplicity of light barrier arrangements each according to claim 1, wherein operational parameters are exchangeable via interface units in different light barrier arrangements.

15. A system for detecting objects in an area of interest including multiple light barrier arrangements, each light barrier arrangement comprising:
a transmitting and a receiving unit, including integrated transmitter/receiver pairs to respectively emit and receive light rays, each transmitting and receiving unit respectively including:
a storage unit to store parameters for the transmitters and receivers; and
an interface unit to transmit the parameters to and receive the parameters from a different one of the light barrier arrangements.

16. A multiple arrangement of sensors, each sensor comprising:
a storage unit to store sensor parameters; and
an interface unit to transmit the sensor parameters to and receive the sensor parameter from another one of the sensors.

17. The multiple arrangement according to claim 16, wherein at least the one sensor is embodied differently from the other sensors.

18. The multiple arrangement according to claim 16, wherein the sensors comprise optical sensors.
